(19) United States
(12) Patent Application Publication
(10) Pub. No.: US 2007/0262960 A1
(43) Pub. Date: Nov. 15, 2007

(54) Mouse With Camera For Separation and Attachment

(76) Inventor: Ho-Gyu Kim, Seoul (KR)

Correspondence Address: NIXON & VANDERHYE, PC, 901 NORTH GLEBE ROAD, 11TH FLOOR, ARLINGTON, VA, 22203, US

(21) Appl. No.: 11/664,729

(22) PCT Filed: Oct. 7, 2005
(86) PCT No.: PCT/KR05/03328

§ 371 Date: Apr. 5, 2007

(30) Foreign Application Priority Data
Oct. 8, 2004 (KR) 10-2004-0080336

(51) Int. Cl. G09G 5/08

(52) U.S. Cl. 345/166

(57) ABSTRACT

Provided is a mouse into or from which a camera can be inserted or removed. The mouse includes space into or from which a camera can be inserted or removed and a window in a bottom thereof such that an external image input to the mouse through the window can be reflected within the mouse and then reach a lens of the camera inserted thereinto. Therefore, the camera can be inserted or removed from the mouse, and both the mouse and the camera functions can be used simultaneously.

### TECHNICAL FIELD

The present invention relates to a computer mouse, and more particularly, to a mouse in or from which a camera can be inserted or removed.

2. Background Art

As Internet connection service through one-dimensional (1D) or two-dimensional (2D) barcode recognition becomes prevalent, barcode recognition apparatuses and met hods using personal computer (PC) cameras, PDA cameras, or mobile phone cameras are being widely used. However, when barcodes are read using such cameras, the distance between a camera and a barcode as well as the focus of the camera must be manually adjusted. In addition, when a plurality of barcodes are arranged, it is difficult to choose one of them.

To solve these problems, a camera-embedded mouse has been suggested. A conventional camera-embedded mouse fixes a focal distance between a code image and the embedded camera. Therefore, when the camera-embedded mouse is focused on a desired code image, the code image can be easily read.

However, when a conventional camera-embedded mouse is used, since the embedded camera moves as the mouse moves, a unique function of the camera is limited. In addition, when the camera is used for video communication, the mouse cannot perform its unique function. In other words, the conventional camera-embedded mouse can perform only one of its functions at a time but cannot perform the two functions simultaneously.

Furthermore, since an input window of the camera is disposed in a lower part of the mouse, the camera receives images only at a position corresponding to where the mouse is. Thus, the camera cannot be flexibly used. Also, it is virtually impossible to use the camera for video communication because the focal distance of the camera is fix ed. As a result, an additional camera is required for video communication. For a PC to use two cameras, a camera to be used must be chosen by a user or a computer program. In particular, a complicated program may be required to use two cameras simultaneously.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1E illustrate a structure of a mouse according to an embodiment of the present invention;

FIGS. 2A and 2B illustrate a structure of a camera installed in the mouse of FIGS. 1A through 1E according to an embodiment of the present invention;

FIGS. 3A through 3C illustrate a structure of a mouse according to another embodiment of the present invention;

FIGS. 4A through 4C illustrate a structure of a camera installed in the mouse of FIGS. 3A through 3C according to another embodiment of the present invention;

FIGS. 5A through 5F illustrate a mouse structured such that a camera can easily be inserted or removed therein or therefrom according to another embodiment of the p resent invention;

FIGS. 6A through 6C illustrate a structure of a mouse which can adjust the focus of a camera installed therein according to another embodiment of the present invention;

FIGS. 7A through 7C illustrate a structure of a mouse which can adjust a focal distance of a camera installed therein according to another embodiment of the present invention;

FIGS. 8A through 8B are views for illustrating data communication of a camera installed in a mouse according to another embodiment of the present invention;

FIGS. 9A through 9E illustrate a structure of a mouse according to another embodiment of the present invention;

FIGS. 10A through 10C illustrate a structure of a connection unit according to an embodiment of the present invention; and

FIGS. 11A through 11C illustrate a structure of a mouse according to another embodiment of the present invention.

### DETAILED DESCRIPTION OF THE INVENTION

1. Technical Goal of the Invention

The present invention provides a mouse into or from which a camera can be inserted or removed and which can perform both mouse and camera functions simultaneously by adjusting a focal distance of the camera when installed therein.

The present invention also provides a mouse which can perform both mouse and camera functions simultaneously by moving a lens of a camera installed therein up and down such that images can be input thereto not only from positions corresponding to the bottom of the mouse but also from positions corresponding to upper parts of the mouse.

The present invention also provides a mouse which can perform both mouse and camera functions by moving a camera installed therein up, down, right, and left.

2. Disclosure of the Invention

According to an aspect of the present invention, there is provided a mouse including: a camera accommodating unit into or from which a camera can be inserted or removed through a side thereof; an image input window formed in a bottom of the mouse; and a reflector which reflects an external image input through the image input window toward a lens of a camera inserted into the camera accommodating unit.

According to another aspect of the present invention, there is provided a mouse including: a camera accommodating unit having space for accommodating a camera; a first image input window formed in a bottom of the mouse; and a second image input window formed in a portion of a top surface of the mouse, wherein a lens of a camera installed in the camera accommodating unit can move up and down, the lens of the camera can reach the first image input window when the lens of the camera is moved down, and the lens of the camera can reach the second image input window when the lens of the camera is moved up.

According to another aspect of the present invention, there is provided a mouse including: a main body having a groove of a predetermined size at a side thereof; a camera accommodating unit which has a size equal to that of the groove and into or from which a camera is inserted or removed; a connection unit which connects the camera accommodating unit to the main body of the mouse such that the camera accommodating unit can rotate about the connection unit; and an image input window formed in a bottom of the mouse and through which an image can be input to a lens of the camera.

### EFFECT OF THE INVENTION

According to the present invention, a camera can be inserted into or removed from a mouse, and a focal distance of the camera can be adjusted. Also, an external image can be enlarged or reduced. Since the camera installed in the mouse can rotate in all directions, it can not only scan images, such as barcodes and 2D codes, at the bottom of the mouse but also images elsewhere. Therefore, there is no need to remove the camera from the mouse for video communication.

### BEST MODE FOR CARRYING OUT THE INVENTION

According to an aspect of the present invention, there is provided a mouse including: a camera accommodating unit into or from which a camera can be inserted or removed through a side thereof; an image input window formed in a bottom of the mouse; and a reflector which reflects an external image input through the image input window toward a lens of a camera inserted into the camera accommodating unit.

According to another aspect of the present invention, there is provided a mouse including: a camera accommodating unit having space for accommodating a camera; a first image input window formed in a bottom of the mouse; and a second image input window formed in a portion of a top surface of the mouse, wherein a lens of a camera installed in the camera accommodating unit can move up and down, the lens of the camera can reach the first image input window when the lens of the camera is moved down, and the lens of the camera can reach the second image input window when the lens of the camera is moved up.

According to another aspect of the present invention, there is provided a mouse including: a main body having a groove of a predetermined size at a side thereof; a camera accommodating unit which has a size equal to that of the groove and into or from which a camera is inserted or removed; a connection unit which connects the camera accommodating unit to the main body of the mouse such that the camera accommodating unit can rotate about the connection unit; and an image input window formed in a bottom of the mouse and through which an image can be input to a lens of the camera.

### EMBODIMENTS

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

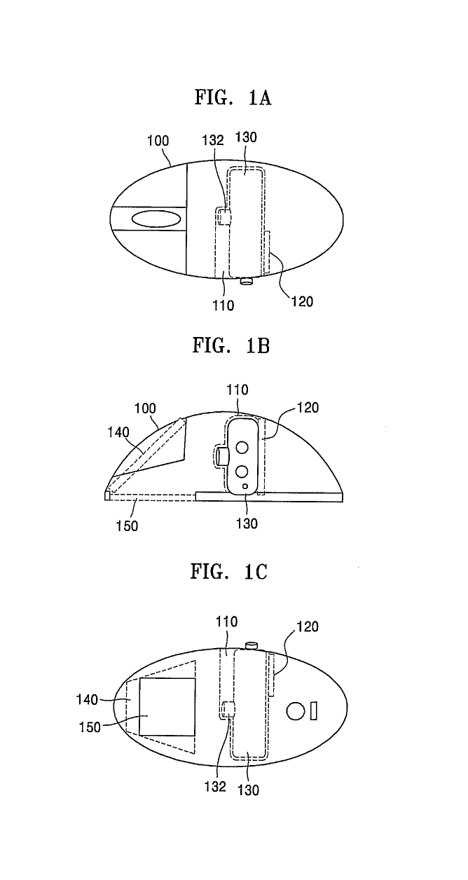

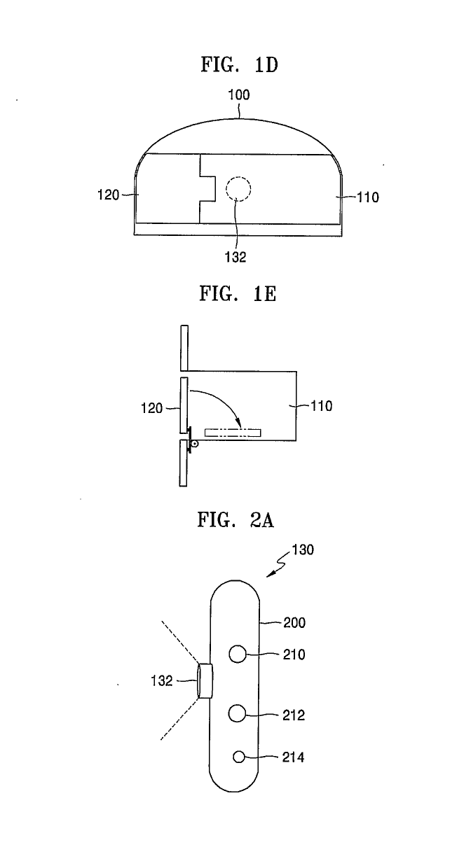

FIGS. 1A through 1E illustrate a structure of a mouse 100 according to an embodiment of the present invention. Specifically, FIG. 1A is a top view of the mouse 100. FIG. 1B is a side view of the mouse 100. FIG. 1C is a bottom view of the mouse 100.

FIG. 1D is a rear view of the mouse 100. FIG. 1E is a cross section of a cover 120 which is connected to a camera accommodating unit 110 into or from which a camera 130 is inserted or removed.

Referring to FIGS. 1A through 1C, the mouse 100 includes the camera accommodating unit 110 into or from which the camera 130 is inserted or removed, the cover 120 connected to the camera accommodating unit 110 into or from which the camera 130 is inserted or removed, an image input window 150 into which an external image is input, and a reflector 140 which reflects the image toward a lens 132 of the camera 130.

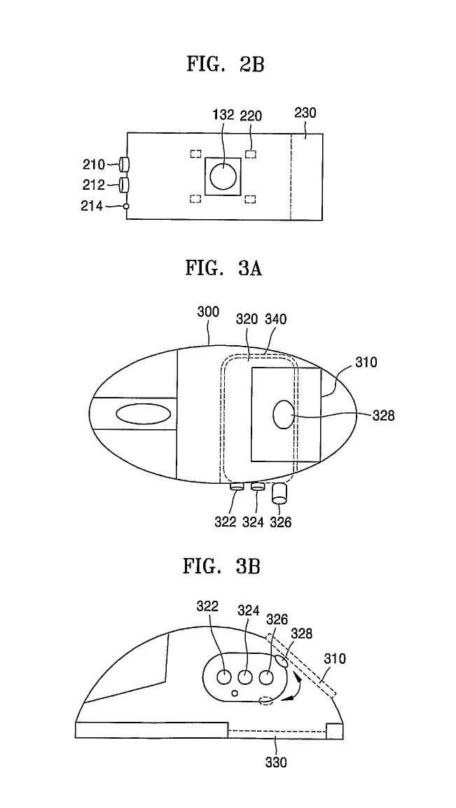

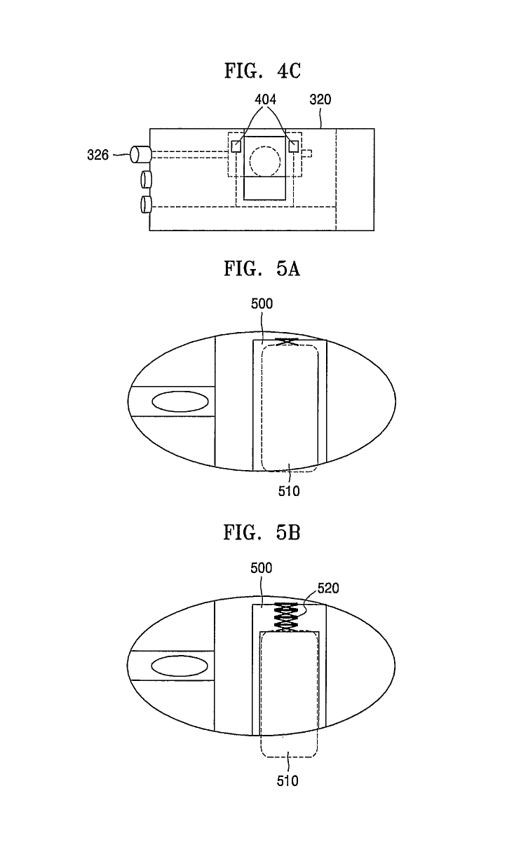

The structure of the camera accommodating unit 110 is determined by the size of the camera 130 to be inserted thereinto. The structure of the camera 130 is illustrated in FIGS. 2A and 2B. For example, unless a lens protrudes from a camera as illustrated in FIGS. 4A through 4C, the structure of the camera accommodating unit 110 is dependent on the size of the camera 130.

The camera accommodating unit 110 includes the cover 120. When the camera 130 is removed from the mouse 100, the cover 120 covers the camera accommodating unit 110. As illustrated in FIG. 1E, since the cover 120 can be folded toward the inside of the camera accommodating unit 110, the camera 130 can be inserted therein. In addition, when the camera 130 is removed from the mouse 100, the cover 120 prevent dust or foreign matter from entering the mouse 100.

The image input window 150 is formed in the bottom of the mouse 100, and an external image is input to the camera 130 through the image input window 150. The image input window 150 may simply be a window or may be formed of transparent material such as glass or transparent plastic. When the image input window 150 is formed of glass or transparent plastic, it can effectively prevent dust or foreign matter from entering the mouse 100.

The reflector 140 reflects an image input through the image input window 150 to ward the lens 132 of the camera 130 installed in the camera accommodating unit 110. If the lens 132 of the camera 130 installed in the camera accommodating unit 110 receives an external image directly from the image input window 150, the distance between the external image and the lens 132 of the camera 130 is too short, thus making it difficult to adjust the focus of the camera 130. Therefore, to increase the distance between the external image and the lens 132 of the camera 130, the external image is reflected by the reflector 140 before reaching the lens 132 of the camera 130.

FIGS. 2A and 2B illustrate the structure of the camera 130 installed in the mouse 100 according to the current embodiment of the present invention. Specifically, FIG. 2A is a side view of the camera 130. FIG. 2B is a front view of the camera 130.

Referring to FIGS. 2A and 2B, the camera 130 includes a main body 200 and the lens 132. The lens 132 may protrude from the camera 130 as illustrated in FIG. 2A or may not protrude from the camera 130 as illustrated in 4A. The camera 130 include a light switch 210, a camera function switch 212, and a camera operation indicator 214. The camera function switch 212 is used to provide functions such as a snapshot function, and the light switch 210 is used to turn the flash of the camera 130 on or off. Without the light switch 210, a light 220 may be automatically turned on or off according to the environment of the camera 130. The light 220 may be installed in the mouse 100 instead of the camera 130.

The camera 130 also includes a power/interface unit 230. The power/interface unit 230 transmits or receives data to or from a computer through a wireless or wired network.

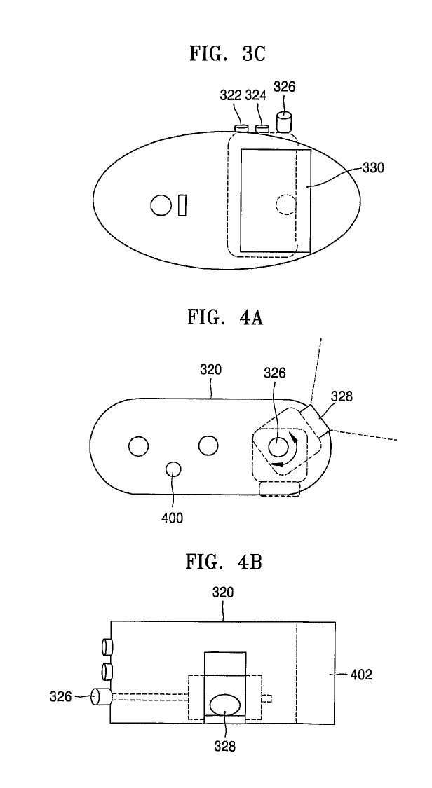

FIGS. 3A through 3C illustrate a structure of a mouse 300 according to another embodiment of the present invention. Specifically, FIG. 3A is a top view of the mouse 300. FIG. 3B is a side view of the mouse 300. FIG. 3C is a bottom view of the mouse 300.

Referring to FIGS. 3A through 3C, the mouse 300 includes a camera accommodating unit 340 into or from which a camera 320 is inserted or removed, a first image input window 330 in the bottom of the mouse 300, and a second image input window 310 in an upper part of the mouse 300.

As illustrated in FIGS. 3A through 3C, the structure of the camera accommodating unit 340 is determined by the structure of the camera 320 to be inserted thereinto. The camera accommodating unit 340 includes a cover at its entrance where the camera 320 is inserted. Alternatively, the camera 320 may be fixed in the mouse 300 without the camera accommodating unit 340.

Referring to FIGS. 4A through 4C, the camera 320 can receive external images through the second image input window 310 in the upper part of the mouse 300 and the first image input window 330 in the bottom of the mouse 300 using the lens 328 that can move up and down. The camera 320 will be described in more detail later with reference to FIGS. 4A through 4C.

The lens 328 of the camera 320 illustrated in FIGS. 3A through 3C can move up and down. However, the camera accommodating unit 340 itself may move up, down, right, and left by being fixed to a predetermined axis of the mouse 300. In this case, the lens 328 of the camera 320 may be fixed.

The first image input window 330 is disposed in the bottom of the mouse 300, and images such as barcodes or 2D image codes can reach the lens 328 of the camera 320 therethrough. Here, the lens 328 of the camera 320 is adjusted to face the first image input window 330.

The second image input window 310 is disposed in the upper part of the mouse 300 such that external images can reach the lens 328 of the camera 320 therethrough.

Therefore, a user does not have to remove the camera 320 from the mouse 328 for video communication. Instead, external images can be input to the camera 320 through the second image input window 310 formed in the upper part of the mouse 300. Therefore, the camera 320 can perform its unique camera function.

FIGS. 4A through 4C illustrate the structure of the camera 320 installed in the mouse 300 of FIGS. 3A through 3C according to the current embodiment of the present invention.

Unlike the lens 132 of the camera 130 illustrated in FIGS. 2A and 2B, a lens 328 of the camera 320 illustrated in FIGS. 4A through 4C can move up and down. The lens 328 of the camera 320 moves up and down to receive images through either of the first and second image input windows 310 and 330. If the camera accommodating unit 340 of the mouse 300 illustrated in FIGS. 3A through 3C can rotate up and down, the camera 130 of the previous embodiment illustrated in FIGS. 2A and 2B having the fixed lens 132 can be used.

Therefore, the camera 320 of FIGS. 4A through 4C includes a camera operation indicator 322, a light switch 324, and a lens-angle-adjusting switch 326. A user can move the lens 328 up and down by turning the lens-angle-adjusting switch 326 in a clockwise or counter-clockwise direction. Lights 404 are disposed at the periphery of the lens 328 and are used for inputting images in a dark environment. The lights 404 may be installed around the first and second image input windows 330 and 310, respectively, of the mouse 300 to which external images are input.

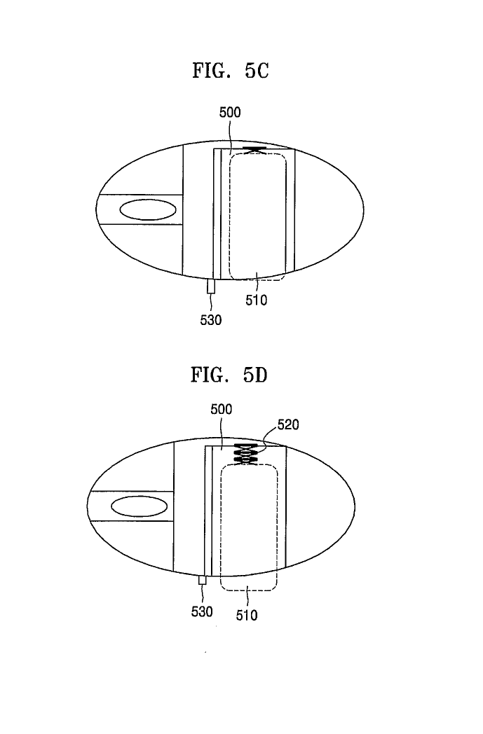

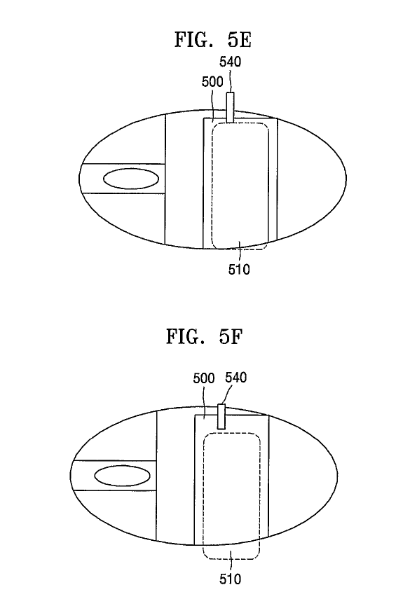

FIGS. 5A through 5F illustrate a mouse structured such that a camera 510 can easily be inserted or removed thereto or therefrom according to another embodiment of the present invention. Referring to FIGS. 5A and 5B, a camera accommodating unit 500 of the mouse includes a spring 520 disposed in the bottom thereof in a direction in which the camera 510 is inserted. When pressed once, the spring 520 becomes compressed. When pressed again, the spring 520 returns to its original state. Since the spring 520 is well known to those of ordinary skill in the art, a detailed description thereof will be omitted.

When a user inserts the camera 510 into the camera accommodating unit 500 of the mouse and thus presses the spring 520, the spring 520 becomes compressed. When the user presses the camera 510 further in an insertion direction and thus presses the spring 520 again, the spring 520 returns to its original state, thereby ejecting the camera 510 out of the mouse.

Referring to FIGS. 5C and 5D, an external switch 530 is used to press the spring 520. When a user inserts the camera 510 into the mouse and thus presses the spring 520, the spring 520 becomes compressed. When the user presses the switch 530 to remove the camera 510 from the mouse, the spring 520 is released from the compressed state and expands, thereby ejecting the camera 510 out of the mouse.

Referring to FIGS. 5E and 5F, the camera accommodating unit 500 of the mouse includes an ejection button 540 which is connected to the outside and disposed in the bottom thereof in a direction in which the camera 510 is inserted. The camera 510 can easily be ejected to the outside by pressing the switch 540.

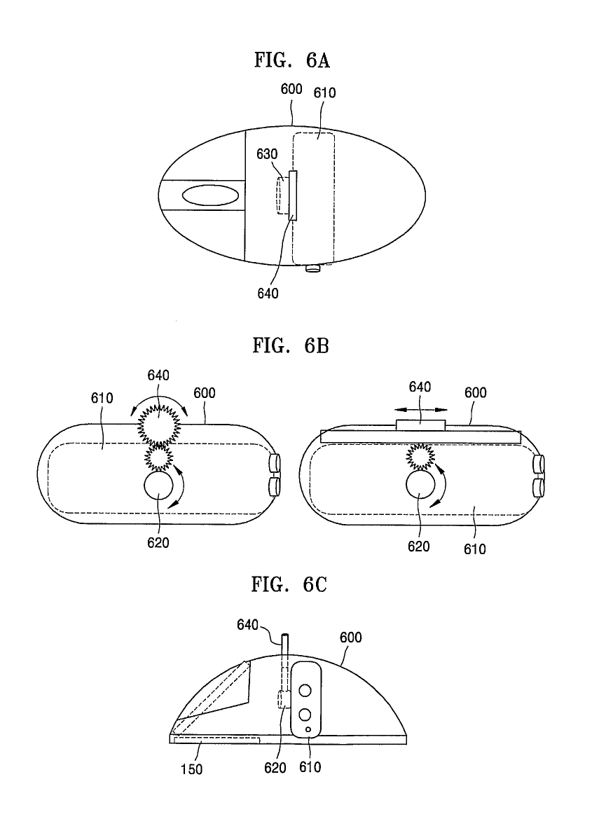

FIGS. 6A through 6C illustrate the structure of a mouse 600 which can adjust the focus of a camera 610 installed therein according to another embodiment of the present invention.

Referring to FIGS. 6A through 6C, the mouse 600 includes an adjusting wheel 640 which is connected to a lens focus adjuster 630 for adjusting the focus of a lens 620 of the camera 610. When the adjusting wheel 640 connected to the outside is turned, the lens focus adjuster 630 of the lens 620, which is engaged with the adjusting wheel 640 by at least one saw-toothed wheel, moves. As a result, the focus of the lens 620 of the camera 610 is adjusted.

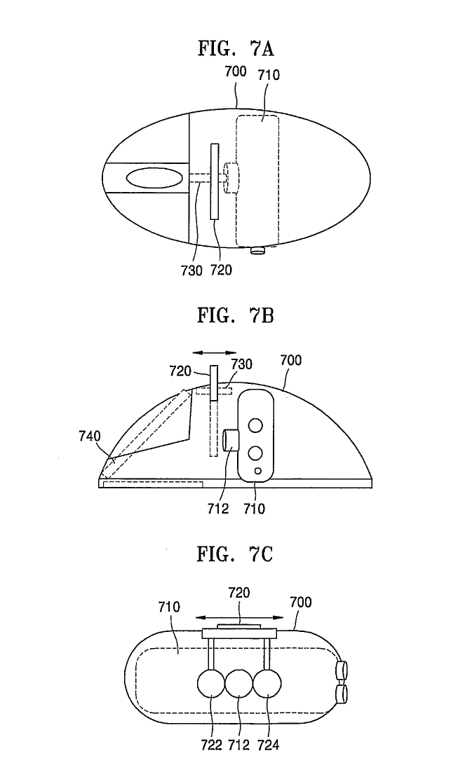

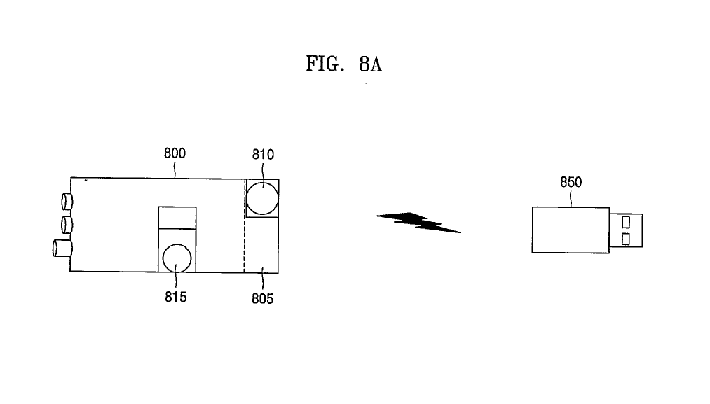

FIGS. 7A through 7C illustrate a structure of a mouse 700 which can adjust a focal distance of a camera 710 installed therein according to an embodiment of the present invention.

Since a camera is fixed in a conventional camera-embedded mouse, when an image is input to the camera for image recognition, the size of the image is also fixed. Therefore, the resolution of the image may be improved by adjusting the focus of the camera but the size of the image cannot be adjusted.

If the code is very small, the size of the image input to the camera is also small. Thus, a number of pixels constituting the image may be very small. Consequently, a minimum number of pixels required for image recognition may not be obtained.

In the case of barcodes, a barcode value is obtained by analysing a pattern of differences between widths of black and white bars. Since each bar can be one of four widths, the minimum number of pixels required for the widest bar is four. However, if a c ode image is too small, the minimum number of pixels cannot be obtained. As a result, the code image cannot be recognized or is wrongly recognized. Conversely, if a code is too big, so is a code image. As a result, the code image is recognized in too much detail, and thus even unnecessary images are recognized.

Referring to FIGS. 7A through 7C, a convex lens 722 and a concave lens 724 are interposed between a reflector 740 and a lens 712 of the camera 710. A focal distance adjusting switch 720 on a surface of the mouse 700 is shaped like a long stick, and the convex lens 722 and the concave lens 724 are respectively connected to predetermined positions of the long stick. The focal distance adjusting switch 720 is moved in one direction such that the convex lens 722 or the concave lens 724 is put on a path in which an external image reflected by the reflector 740 reaches the lens 712.

The convex lens 722 enlarges an image, and the concave lens 724 reduces an image. Therefore, an external image can be enlarged or reduced using the convex lens 722 or the concave lens 724, respectively. In particular, when a code image for Internet connection is input, the code image, if too small or too large, can be properly enlarged or reduced using the convex lens 722 or the concave lens 724, respectively.

The focal distance adjusting switch 720 includes a structure 730 that can move forward and backward and adjusts the distance between the lens 712 of the camera 710 and the convex lens 722 or the concave lens 724.

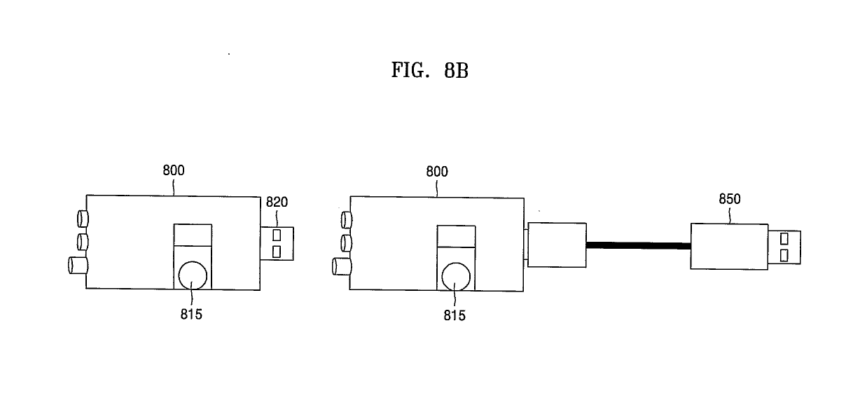

FIGS. 8A through 8B are views for illustrating data communication of a camera 800 installed in a mouse according to another embodiment of the present invention.

Referring to FIGS. 8A through 8B, the camera 800 can exchange data with a computer through a wireless or wired network. FIG. 8A illustrates wireless communication. The camera 800 includes an internal power unit 810 and an interface unit 805 to wirelessly communicate with an external device 850. Wireless communication means may include infrared communication and Bluetooth communication.

FIG. 8B illustrates wired communication. Generally, a universal serial bus (USB) is used for wired communication. In wired communication, the camera 800 is supplied with power through a USB 820. Thus, the camera 800 does not need an internal power unit. When a USB communication method is used, a USB hub may be included in the mouse and the camera 800 may be connected to the USB hub. The mouse according to the present invention may be connected to a computer in a wired or wireless manner.

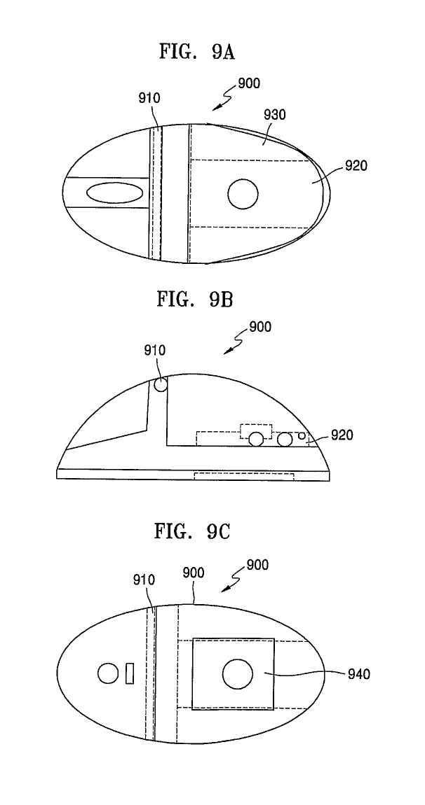

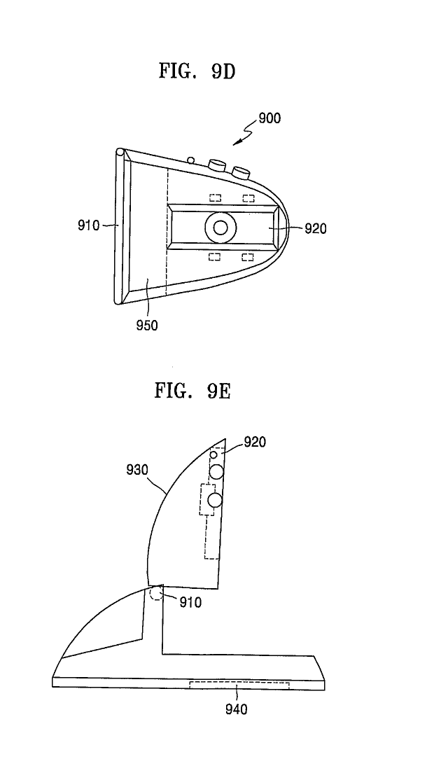

FIGS. 9A through 9E illustrate a structure of a mouse 900 according to another embodiment of the present invention. Referring to FIGS. 9A through 9C, a camera 920 is not inserted into or removed from the mouse 900, unlike the mice described in the previous embodiments. Instead, a camera accommodating unit 930, i.e., a rear portion of the mouse 900, is separated or moved.

The camera 920 may be fixed in the camera accommodating unit 930 or inserted into or removed from the camera accommodating unit 930. If the camera 920 can be inserted into or removed from the camera accommodating unit 930, the structure of the camera accommodating unit 110 illustrated in FIGS. 1A through 1C may be applied.

The camera accommodating unit 930 is connected to a main body of the mouse 900 by a connection unit 910. The connection unit 910 is shaped like a hinge. Specifically, the connection unit 910 is a long bar and implemented in the main body of the mouse 900 and the camera accommodating unit 930. The camera accommodating unit 930 can be connected to the main body of the mouse 900 by the long bar, i.e., the connection unit 910, which is inserted into a cylindrical groove formed in the main body of the mouse 900. Therefore, the camera accommodating unit 930 can move about the connection unit 910 as illustrated in FIG. 9E.

For wireless communication of the camera 920, the camera accommodating unit 930 includes a power/wireless interface unit 950. For wired communication of the camera 920, the camera accommodating unit 930 includes an interface unit for connection with the main body of the mouse 900 or a computer.

An image input window 940 is included in the bottom of the mouse 900, and the camera 920 is installed in the camera accommodating unit 930 to face the image input window 940. Therefore, when a user moves the camera accommodating unit 930 up, the camera 920 can take photographs of images elsewhere. In other words, the camera 920 can perform its unique function.

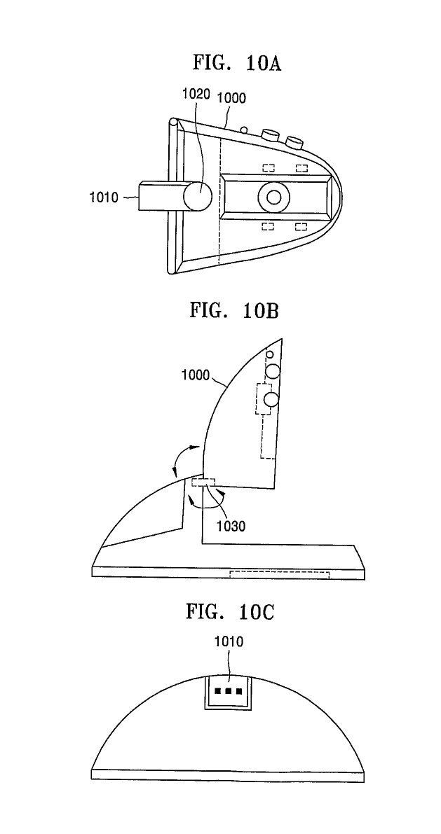

FIGS. 10A through 10C illustrate a structure of a connection unit 1030 according to another embodiment of the present invention. Referring to FIGS. 10A and 10B, the connection unit 1030 implemented in a camera accommodating unit 1000 includes a USB port 1010 and a rotation unit 1020. For wired communication of a camera, the USB port 1010 is connected to a USB hub of a mouse.

FIG. 10C is a cross-sectional view of the USB port 1010. The camera accommodating unit 1000 can be fixed to a main body of the mouse by inserting the USB port 1010 into the USB hub of the mouse. The camera accommodating unit 1000 includes the rotation unit 1020. Since the rotation unit 1020 is formed by inserting a ball into a circular socket, it can rotate in all directions. The USB port 1010 is not required for wireless communication. Thus, in this case, the USB port 1010 can be used for connection with the main body of the mouse.

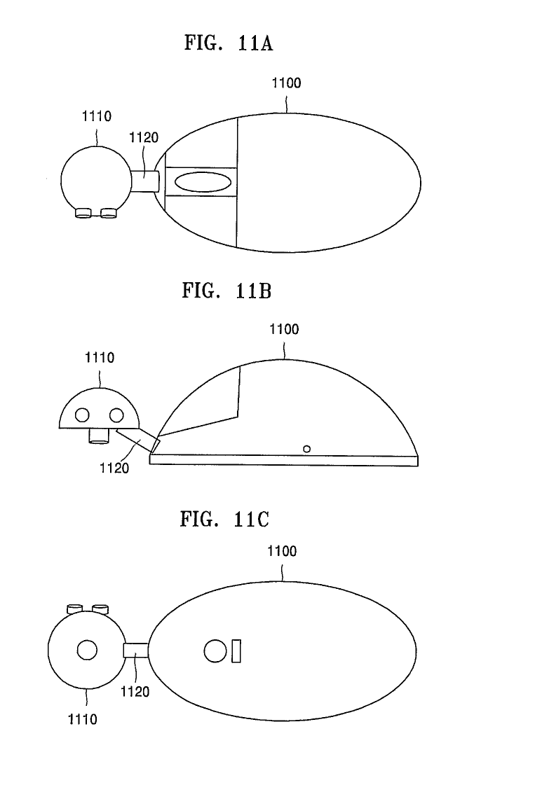

FIGS. 11A through 11C illustrate a structure of a mouse 1100 according to another embodiment of the present invention. Referring to FIGS. 11A through 11C, the mouse 1100 includes a port 1120 in a USB, serial, parallel, or IEE1394 form, and a camera 1110 can be inserted into or removed from the slot 1120.

For wireless communication of the camera 1110, a hanger or a port may be transformed and installed in the mouse 1100. A fixed device shaped like a prop, ring, or clip may be attached to the camera 1110 such that the camera 1110, when removed from the mouse 1100, can be set up somewhere for video communication.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mouse comprising:
a camera accommodating unit into or from which a camera can be inserted or removed through a side thereof;
an image input window formed in a bottom of the mouse; and
a reflector which reflects an external image input through the image input window toward a lens of a camera inserted into the camera accommodating unit.

2. The mouse of claim 1, wherein the image input window is formed of transparent material.

3. The mouse of claim 1, further comprising a focus adjuster disposed on the mouse and connected to a lens focus adjuster of the camera inserted into the camera accommodating unit.

4. The mouse of claim 1, further comprising a focal distance adjuster which is disposed on a side of the mouse and is connected to a concave lens and a convex lens, and which moves the concave lens and the convex lens on a surface, which is perpendicular to a path through which the external image passes, between the reflector and a lens of the camera.

5. The mouse of claim 4, wherein the focal lens adjuster can move the concave lens and the convex lens forward and backward to be parallel to the path through which the external image passes.

6. A mouse comprising:
a camera accommodating unit having space for accommodating a camera;
a first image input window formed in a bottom of the mouse; and
a second image input window formed in a portion of a top surface of the mouse,
wherein a lens of a camera installed in the camera accommodating unit can move up and down, the lens of the camera can reach the first image input window when the lens of the camera is moved down, and the lens of the camera can reach the second image input window when the lens of the camera is moved up.

7. The mouse of claim 6, wherein the camera accommodating unit into or from which the camera can be inserted or removed through a side of the mouse.

8. The mouse of claim 1, wherein the camera accommodating unit comprises a cover at a side thereof where the camera is inserted or removed, wherein the cover covers the camera accommodating unit when the camera is removed from the camera accommodating unit and is folded toward an inside of the camera accommodating unit when the camera is inserted into the camera accommodating unit.

9. The mouse of claim 1, wherein the camera accommodating unit comprises a spring in a bottom of the space inside thereof, wherein the spring becomes compressed when pressed once and returns to its original state when pressed again.

10. The mouse of claim 1, wherein a camera having lights around a lens thereof is inserted into or removed from the camera accommodating unit.

11. The mouse of claim 1, wherein a camera wirelessly communicating with a computer is inserted into or removed from the camera accommodating unit.

12. The mouse of claim 1, further comprising an interface unit which is connected to the camera installed in the camera accommodating unit, supplies power, and performs data communication.

13. A mouse comprising:
a main body having a groove of a predetermined size at a side thereof;
a camera accommodating unit which has a size equal to that of the groove and into or from which a camera is inserted or removed;
a connection unit which connects the camera accommodating unit to the main body of the mouse such that the camera accommodating unit can rotate about the connection unit; and
an image input window formed in a bottom of the mouse and through which an image can be input to a lens of the camera.

14. The mouse of claim 13, wherein the connection unit connects a first circular socket, which is formed in the main body of the mouse and which has an open portion, to a circular ball formed in the camera accommodating unit at a position corresponding to the first socket such that the camera accommodating unit can rotate in all directions.
